(19) United States
(12) Patent Application Publication
(10) Pub. No.: US 2007/0003697 A1
(43) Pub. Date: Jan. 4, 2007

(54) Lattice-matched AllnN/GaN for optoelectronic devices

(76) Inventors: Jean-Francois Carlin, Ecublens (CH); Marc Ilegems, Preverenges (CH)

Correspondence Address: Peter A. Businger, Esq., 344 Valleyscent Avenue, Scotch Plains, NJ, 07076-1170, US

(21) Appl. No.: 10/900,514

(22) Filed: Jul. 28, 2004

(51) Int. Cl. B05D 1/36

(52) U.S. Cl. 427/248.1; 427/402

(57) ABSTRACT

High-quality Al₁₋ₓInₓN layers and AlInN/GaN Bragg mirrors near lattice-matched to GaN layers are grown by metalorganic vapor-phase epitaxy on a GaN buffer layer with no cracks over full 2-inch sapphire wafers. The index contrast relative to GaN is 6.5% to 11% for wavelengths ranging from 950 nm to 380 nm. A crack-free, 20 pairs Al_{0.84}In_{0.16}N/GaN distributed Bragg reflector is grown, centered at 515 nm with over 90% reflectivity and a 35 nm stopband. High-quality AlInN lattice matched to GaN can be used in GaN-based optoelectronics, for waveguides and for mirror structures in resonant-cavity light-emitting diodes and monolithic Fabry-Pérot cavities, for example.

### FIELD OF THE INVENTION

The invention is concerned with Group III-Nitride optoelectronic devices which, more particularly, include a Bragg reflector element or an in-plane waveguide.

### BACKGROUND OF THE INVENTION

AlInN materials hold great potential for GaN-based optoelectronics. Alloys with indium content between 14% and 22%, which are within a ±0.5% lattice mismatch to GaN, would be of special interest if they prove to exhibit a sufficiently high bandgap and refractive index contrast with GaN. Indeed. AlGaN is presently the standard material for optical engineering of GaN-based devices, but the requirement of achieving a high index contrast while at the same time avoiding the generation of cracks due to the lattice mismatch to GaN are opposites. As a consequence, for nitride-based laser diodes, AlGaN waveguide cladding layers are used with hardly more than 10% Al content (having 0.25% lattice mismatch) and an index contrast that does not exceed 2%.

Distributed Bragg reflectors (DBRs) are subject to the same issue. Over 50% Al content can be used in AlGaN/GaN DBRs with no cracks, but in this case the entire structure relaxes to an average in-plane lattice parameter. As a result, GaN/GaInN multi-quantum-well (MQW) active layers grown on top of such DBRs are no longer lattice-matched, and strain relaxation issues may arise in the active zone. Thus, where AlGaN/GaN DBRs has been demonstrated in devices, e.g,. in resonant-cavity light-emittinig diodes (RCLEDs), Al contents has been kept below 30%, at the price of a reduced optical stopband. As yet, AlInN has found little use in optoelectronic devices mainly because growth is difficult due to phase separation. There remains considerable uncertainty concerning the bandgap of AlInN lattice-matched to GaN, as values ranging from 2.8 eV to 4.2 eV have been reported by different groups.

### SUMMARY OF THE INVENTION

A reflector structure or in-plane waveguide is formed on a substrate, for electromagnetic radiation at a wavelength in a preferred wavelength range from 280 nm to 1600 nm. The structure includes aluminum-indium-nitride-based material, lattice matched to gallium-nitride- or aluminum-gallium-nitride-based material. In the latter, inclusion of aluminum is preferred especially for wavelengths less than 380 nm.

### BRIEF DESCRIPTION OF THE DRAWING

FIG. 1 is a diagram of (0002) X-ray diffraction rocking curves of a 20-pair AlInN/GaN DBR and of a single 0.5 μm AlInN layer grown on GaN buffer layers.

FIG. 2 is a diagram of evolution of the reflectivity at 950 nm wavelength during the growth of an AlInN/GaN DBR matched to the measurement wavelength. The inset shows the index contrast calculated from the period-to-period increase of the reflectivity signal.

FIG. 3 is a diagram of AlInN/GaN optical index contrast versus AlInN indium content, calculated from in situ reflectivity experiments (950 nm wavelength) and from ex situ analysis of shorter wavelengths DBRs (455 nm and 515 nm).

FIG. 4 is a diagram of index contrast versus lattice mismatch to GaN: comparison between AlInN/GaN and AlGaN/GaN materials systems.

FIG. 5 is a diagram of experimental reflectivity spectra of AlInN/GaN distributed Bragg reflectors.

### DETAILED DESCRIPTION

Growth has been achieved of Al_{0.84}In_{0.16}N/GaN DBRs near lattice-matched to GaN. Such DBRs are optically equivalent to state-of-the art Al_{0.6}Ga_{0.4}N/GaN mirrors and avoid the issues related to strain. Layers were grown in an AIXTRON 200/4 RF-S metalorganic vapor phase epitaxy system, on 2-inch c-plane sapphire substrates. The growth was initiated by a low-temperature GaN nucleation layer followed by a 1 μm thick GaN buffer layer. AlInN was deposited between 800° C. and 850° C. and at 50 to 75 mbar pressure using N₂ carrier gas. Lower growth temperatures led to lower crystalline quality as revealed by high resolution X-ray diffraction (HRXD) (0002) scans. Higher growth temperatures resulted in decreased indium incorporation so that near-lattice matched alloys could no longer be obtained. Deposition rates ranged between 0.6 and 0.2 μm/h. During the DBR runs, growth was interrupted at each interface. GaN was deposited at 1050° C. using H2 and N2 carrier gas.

No degradation of AlInN could be detected on account of thermal cycling as shown in FIG. 1 which compares (0002) HRXD rocking curves of a 0.5 μm Al_{0.84}In_{0.16}N layer with that of a 20 pairs of Al_{0.84}In_{0.16}N/GaN DBR centered at 515 nm wavelength. The HRXD scans were performed without a slit on the detector; in this case the diffracted intensity is integrated over a 5° detector angle, and the full widths at half maximum (FWHM) of the peaks are influenced by both compositions fluctuation and c-axis tilt. The DBR superlattice satellites are not resolved on the DBR sample, as their spacing is too narrow, and the X-ray scan rather reflects the quality of the bulk materials. The single-layer and the DBR sample show identical high crystalline quality, with 360″ FWHM for the Al_{0.84}In_{0.16}N peak, nearly as narrow as the 340″ FWHM GaN peak.

We have evaluated the optical index contrast between AlInN and GaN, Δn/n=(n_{AlIN}−n_{GaN})/n_{GaN}, by recording the reflectivity of the layers in situ during the growth of a few periods of a DBR whose center wavelength matched that of the measurement wavelength. The experimental set-up consisted of a LUXTRON TR-100 using a 950 nm wavelength source under normal incidence, which allows for an absolute reflectivity measurement.

FIG. 2 shows the evolution of reflectivity during a typical run; the growth of the GaN buffer layer is stopped when its maximum reflectivity is reached around 26%, then AlInN is grown during the negative slope of the reflectivity signal, followed by GaN during the positive slope.

If Rᵢ is chosen to denote the reflectivity value after deposition of the i^{th} DBR period, Rᵢ increases with the number of periods starting from the very first period. This already indicates that AlInN has a lower optical index than GaN, otherwise reflections at the AlInN/GaN and GaN/AlInN interfaces would be in anti-phase with the GaN/air and sapphire/GaN reflections, leading to a decrease of Rᵢ during the first periods. As reflections at all interfaces are in phase, the well-known formulas for DBRs reflectivity can be used for calculating the optical index contrast from the period-to-period increase in reflectivity using:

$$\frac{\vert Δ n \vert}{n} ( i ) = 1 - \sqrt{\frac{( 1 + \sqrt{{R}_{i}} ) ( 1 - \sqrt{{R}_{i + 1}} )}{( 1 - \sqrt{{R}_{i}} ) ( 1 + \sqrt{{R}_{i + 1}} )}} \qquad ( 1 )$$

This relationship is valid in the absence of parasitic effects, such as absorption, appearance of cracks or development of surface roughness which decrease the reflectivity. For verification of Equation (1), a plot of Δn/n as a function of the number of periods is shown in the inset of FIG. 2. Any parasitic effect will manifests itself by a decrease of Δn/n. In the case of the run shown in FIG. 2, a marked decrease occurs at the 7^{th} period, and indeed, further examination of the sample revealed the presence of cracks. This sample was still quite near lattice-matched, with an estimated about 0.4% compressive strain. On more mismatched samples, cracks appeared earlier, and in some cases only the first period could be taken into account for index contrast evaluation.

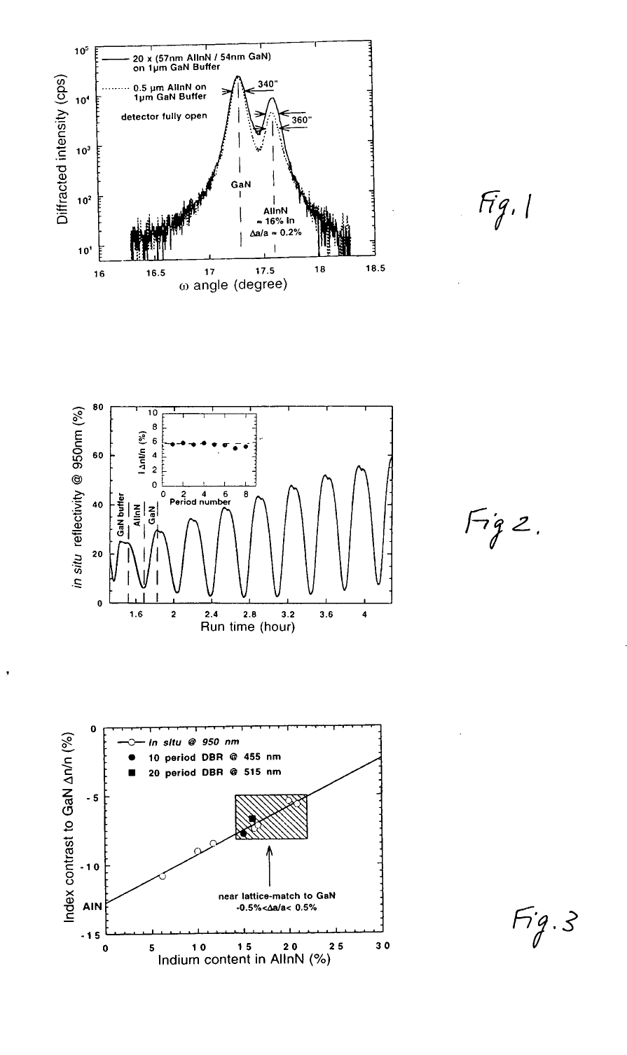

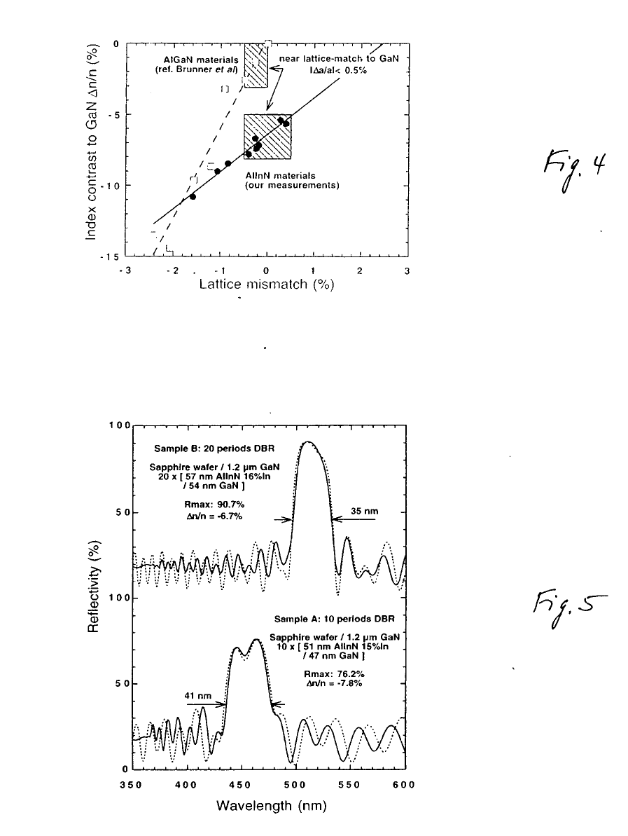

FIG. 3 summarizes the index contrast measured on different samples, and presents the dependence of Δn/n as a function of the indium content as estimated from HRXD (0002) measurements. Open symbols represent the in-situ measurements described above for Δn/n at λ=950 nm and at growth temperature. The two other data points correspond to ex-situ analysis of the blue-green DBRs tuned at 455 nm and 515 nm presented further below. It is noted that the index contrast is not much dependent on wavelength within this range. The experimental data are well fitted by a linear dependence with indium content within the 6% to 21% explored range, according to:

$$\frac{Δ n}{n} ( {Al}_{1 - x} {In}_{x} N / Ga N ) = - 0.127 + 0.35 x \qquad ( 2 )$$

Extrapolation of equation (2) to zero indium content gives a −12.7% index contrast for AlN/GaN, in agreement with literature values.

The advantage of using near lattice matched AlInN as the low-index material is evident from FIG. 4, where the AlInN/GaN index contrast is plotted as a function of lattice mismatch to GaN and compared with that of the AlGaN/GaN material system. A lattice mismatch that lies within ±0.5% is sufficient to avoid relaxation in blue DBR applications. In this case the maximum index contrast achievable with AlGaN/GaN is about 3%, while more than 8% is obtained with AlInN/GaN. The gain is even more pronounced when considering laser applications where the lattice mismatch is rather limited to ±0.25%.

To demonstrate the interest of the AlInN/GaN system. FIG. 5 shows the reflectivity spectra of two AlInN/GaN DBRs having stop bands in the visible wavelength range. Sample A is a 10 period DBR centered at 455 nm, sample B has 20 periods and is centered at 515 nm. Growth and reflectivity data are reported in Table 1. Careful examinations by phase contrast microscopy just after the growth showed that both samples were completely crack-free over the full 2-inch area. However, some cracks—about ten—appeared after some weeks of handling under ordinary conditions without special care. The measurements were performed with a Cary 500 reflectometer in double-reflection mode. The measurement data where fitted with a standard transfer matrix model to extract the index contrast values of FIG. 4. The 10-periods sample shows a maximum reflectivity of 76% with a 41 nm FWHM stopband. For the 20-periods sample, the reflectivity reached over 90% with a 35 nm FWHM stopband. For comparison, Nakada et al., Applied Physics Letters Vol. 79 (2001), p. 1804 have reported 70% and 83% reflectivity respectively for 10 and 20 periods Al_{0.6}Ga_{0.4}N/GaN DBRs relaxed on GaN.

Hall measurements showed a residual donor density of 7·10¹⁷ cm⁻³ in the Al_{0.84}In_{0.16}N layer. This value represents an upper-limit estimate as a bi-dimensional electron gas may be present at the AlInN/GaN interface. Preliminary reflectivity data also indicate the presence of an optical transition around 4.2 eV, in agreement with the value reported for the Al_{0.84}In_{0.16}N bandgap measured on layers deposited by plasma source molecular beam epitaxy and sputtering.

Further preferred embodiments of the invention can include dopants for electrical conductivity, e.g. magnesium for p-type conductivity or silicon for n-type conductivity. Deposited materials can include diluents, e.g. boron, aluminum, gallium, indium, phosphorus, arsenic and/or antimony, typically in a combined amount not exceeding 10 percent. Instead of abrupt compositional changes between layers, compositional transitions can be gradual.

Reflector structures of the invention can be included in optoelectronic devices such as vertical surface emitting lasers, resonant-cavity diodes, light-emitting diodes. Waveguide structures of the invention can further include active regions, as in laser diodes, quantum-cascade lasers and optical modulators, for example.

1. A method for forming a reflector structure having a prescribed reflectivity for electromagnetic radiation comprising a wavelength in a range from 280 nm to 1600 nm, comprising the steps of:
(a) depositing an aluminum indium nitride layer on a substrate-supported layer of one of gallium nitride and aluminum gallium nitride; and
(b) depositing, on the aluminum indium nitride layer, a layer of one of gallium nitride and aluminum gallium nitride; and
(c) repeating steps (a) and (b) a number of times sufficient for the structure to have the prescribed reflectivity.

2. The method of claim 1, wherein depositing the aluminum indium nitride layer comprises depositing by metalorganic vapor-phase epitaxy.

3. The method of claim 2, wherein vapor-phase epitaxy temperature is in a range from 800° C. to 850° C. and pressure is in a range from 50 mbar to 75 mbar.

4. The method of claim 1, wherein depositing comprises including a dopant for one of n-type and p-type conductivity.

5. The method of claim 4, wherein, for p-type, conductivity, the dopant is magnesiumn.

6. The method of claim 4, wherein, for n-type conductivity, the dopant is silicon.

7. The method of claim 1, wherein depositing comprises including at least one diluent material in a total amount of less than 10 percent.

8. The method of claim 7, wherein the diluent material is selected from the group consisting of B, Al, Ga, In, P, As and Sb.

9. The method of claim 1, wherein depositing comprises compositional grading between layers.

10. A vertical surface-emitting laser comprising at least one structure made by the method of claim 1.

11. A resonant-cavity diode comprising at least one structure made by the method of claim 1.

12. A light-emitting diode comprising a structure in the near-field, made by the method of claim 1.

13. A light-emitting diode comprising a structure in the far-field, made by the method of claim 1.

14. A method for forming a substrate-supported planar optical waveguide structure having a relatively low-index core layer between relatively high-index first and second cladding layers, comprising the steps of:
(a) depositing the first cladding layer as an aluminum indium nitride layer;
(b) depositing the core layer as one of a gallium nitride and an aluminum gallium nitride layer; and
(c) depositing the second cladding layer as an aluminum indium nitride layer.

15. The method of claim 14, further comprising formation of an active region in the core layer.

16. A laser diode comprising a structure made by the method of claim 15.

17. A quantum-cascade laser comprising a structure made by the method of claim 15.

18. An optical modulator comprising a structure made by the method of claim 15.
